(19) United States
(12) Patent Application Publication
(10) Pub. No.: US 2007/0242358 A1
(43) Pub. Date: Oct. 18, 2007

(54) Fabry-perot tunable filter

(75) Inventors: Pinyen Lin, Rochester, NY (US); Lalit Keshav Mestha, Fairport, NY (US); Peter M. Gulvin, Webster, NY (US); Yao Rong Wang, Webster, NY (US)

Correspondence Address: Patrick R. Roche;FAY, SHARPE, FAGAN, MINNICH & McKEE, LLP, SEVENTH FLOOR, 1100 SUPERIOR AVENUE, CLEVELAND, OH, 44114-2579, US

(73) Assignee: XEROX CORPORATION

(21) Appl. No.: 11/406,030

(22) Filed: Apr. 18, 2006

(51) Int. Cl. G02B 27/00

(52) U.S. Cl. 359/578

(57) ABSTRACT

A tunable Fabry-Perot filter is supported on a substrate which may be transparent. A transparent support body is supported by the substrate and carries a first reflector. A second reflector is supported on the substrate. The first and second reflectors define a gap therebetween. The size of the gap is adjustable by flexing of the support body to modulate a wavelength of light output by the filter.

### CROSS REFERENCE TO RELATED PATENTS AND APPLICATIONS

Cross-reference is made to the following co-pending, commonly assigned applications, which are incorporated in their entireties, by reference:

U.S. application Ser. No. 11/092,635 (Attorney Docket No. 20040439-US-NP), filed Mar. 30, 2005, entitled “TWO-DIMENSIONAL SPECTRAL CAMERAS AND METHODS FOR CAPTURING SPECTRAL INFORMATION USING TWO-DIMENSIONAL SPECTRAL CAMERAS,” by Mestha et al.;

U.S. application Ser. No. 11/319,395 (Attorney Docket No. 20050923-US-NP), filed Dec. 29, 2005, entitled “SYSTEMS AND METHODS OF DEVICE INDEPENDENT DISPLAY USING TUNABLE INDIVIDUALLY-ADDRESSABLE FABRY-PEROT MEMBRANES,” by Mestha et al.;

U.S. application Ser. No. 11/319,389 (Attorney Docket No. 20050842-US-NP), filed Dec. 29, 2005, entitled “RECONFIGURABLE MEMS FABRY-PEROT TUNABLE MATRIX FILTER SYSTEMS AND METHODS,” by Wang, et al.;

U.S. application Ser. No. 11/016,952 (Attorney Docket No. D/A30712 (A3452)) filed Dec. 20,2004, entitled “FULL WIDTH ARRAY MECHANICALLY TUNABLE SPECTROPHOTOMETER,” by Mestha, et al;

U.S. application Ser. No. 11/092,835 (Attorney Docket No. 20031469-US-NP), filed Mar. 30, 2005, entitled “DISTRIBUTED BRAGG REFLECTOR SYSTEMS AND METHODS,” by Wang, et al.;

U.S. application Ser. No. 10/833,231 (Attorney Docket No. A2517-US-NP), filed Apr. 27, 2004, entitled “FULL WIDTH ARRAY SCANNING SPECTROPHOTOMETER,” by Mestha, et al.; and

U.S. application Ser. No. ______, filed contemporaneously herewith, entitled “PROJECTOR BASED ON TUNABLE INDIVIDUALLY-ADDRESSABLE FABRY-PEROT FILTERS,” by Gulvin, et al. (hereinafter “Gulvin, et al.”)

### BACKGROUND

The exemplary embodiment relates to micro-electromechanical systems. It finds particular application as a robust Fabry-Perot filter which may be formed on a transparent substrate and will be described with particular reference thereto.

Flat panel displays, such as liquid crystal displays (LCDs) are widely used in a variety of applications, including watches, cell phones, and television displays. These displays rely on the combination of light of three primary colors to achieve a range of colors. The range and intensities of the colors which can be achieved with LCDs are often limited. The challenge is still in displaying rich chromatic colors at high resolution and at low power consumption.

MEMS Fabry-Perot tunable filters have been used for many applications including displays and color sensing. In general, a Fabry-Perot filter includes two micro-mirrors separated by a gap. The gap may be an air gap, or may be filled with liquid or other material. The micro-mirrors include multi-layer distributed Bragg reflector (DBR) stacks or highly reflective metallic layers, such as gold. In a tunable device, the distance between the two reflectors can be adjusted to change the transmission wavelength. The space between the two reflectors is also referred to as the size of the gap. Only incident light with a certain wavelength may be able to pass the gap due to interference effect, which is created inside the gap due to multiple reflections. Depending on the gap distance, it is possible to block the visible light completely or transmit close to the maximum.

The Fabry-Perot filter is typically composed of one or two thin films suspended on a silicon wafer. The thickness of each film is usually very small, compared with the overall size of the filter. In consequence, the film has a tendency to break during fabrication or actuation.

### INCORPORATION BY REFERENCE

The following references, the disclosures of which are incorporated by reference in their entireties, are mentioned:

U.S. Pat. No. 6,295,130 to Sun, et al., issued Sep. 25, 2001, discloses a Fabry-Perot cavity spectrophotometer.

U.S. Published Application No. 20050226553, published Oct. 13, 2005, entitled “OPTICAL FILTRATION DEVICE,” by Hugon, et al., discloses wavelength selective optical components for transmitting light in a narrow spectral band, which is centered around a wavelength, and for reflecting the wavelengths lying outside this band. The component includes an input guide conducting light radiation to a tunable filter and means for returning a first part of the radiation reflected by the filter during the first pass in order to perform a second pass through it.

### BRIEF DESCRIPTION

Aspects of the exemplary embodiment relate to a Fabry-Perot filter, a method of forming a filter, and a display system.

In one aspect, a tunable Fabry-Perot filter includes a substrate. A support body is supported by the substrate. The support body includes a transparent support panel which is spaced from the substrate by first and second spaced leg members. A first reflector is supported on the substrate intermediate the first and second leg members. A second reflector is supported on the transparent support panel intermediate the first and second leg members. The first and second reflectors defining a gap therebetween. A driving member adjusts a size of the gap by displacement of the support panel to modulate a wavelength of light output by the filter.

In another aspect, a method of forming a Fabry-Perot filter includes forming a first reflective layer on a surface of a substrate, forming a sacrificial layer over the first reflective layer, forming a second reflective layer over the sacrificial layer, defining vias through the sacrificial layer, forming a support body over the sacrificial layer which extends into the vias, and removing the sacrificial layer to define a gap intermediate the first and second reflective layers.

In another aspect, a display system includes an array of tunable Fabry-Perot filters supported on a common substrate. Each of the filters includes a resiliently flexible transparent support body supported by the substrate. The support body is formed of an organic resin. A first reflector is supported by the substrate. A second reflector is supported by the transparent support body, the first and second reflectors defining a gap therebetween. A size of the gap is adjustable by flexing of the support body to modulate a wavelength of light output by the Fabry-Perot filter.

### BRIEF DESCRIPTION OF THE DRAWINGS

FIG. 1 is a side sectional view of an exemplary Fabry-Perot filter according to one aspect of the exemplary embodiment;

FIG. 2 is a perspective view of a portion of the Fabry-Perot filter of FIG. 1;

FIG. 3 is a schematic view of a display panel incorporating the filter of FIG. 1, according to another aspect of the exemplary embodiment;

FIGS. 4-10 illustrate steps in the formation of the Fabry-Perot filter of FIG. 1;

FIG. 11 illustrates the display panel of FIG. 3 in the form of a window of a building in a first display mode;

FIG. 12 illustrates the window of FIG. 11 in a second display mode;

FIG. 13 illustrates steps of an exemplary method of displaying an image;

FIG. 14 illustrates another embodiment of a Fabry-Perot filter which may be employed in the display system of FIGS. 2 and 11-12; and

FIGS. 15 and 16 illustrate alternative embodiments of a Fabry-Perot filter which is actuated using electrodes that are adjacent to the area through which light enters the cavity.

### DETAILED DESCRIPTION

The exemplary embodiment relates to a robust Fabry-Perot filter, a method for forming the filter, and to an apparatus for displaying electronically stored information in a human readable form which incorporates the filter.

In various aspects, the Fabry-Perot filter includes first and second spaced reflectors, which define a gap therebetween. A first of the reflectors is carried by a transparent substrate. A second of the reflectors is suspended by a flexible member having a supporting surface which is generally coextensive with a planar surface of the reflector.

In various aspects, the display may be an automotive transparency, a commercial window, a residential window, a commercial sign, an advertising display, and an insulating glass unit.

Various exemplary systems and methods disclosed herein provide a robust two-dimensional matrix display system. The display system may include a Fabry-Perot cavity array illuminated by natural or artificial light. Each cavity may be tuned to transmit colors of color-separated incoming image pixels. For each color-separated image pixel, multiple gray (brightness) levels may be achieved through time-division multiplexing of the transmitted light. In various exemplary systems and methods, the display system may be a two-dimensional flat panel matrix display system, with each individual pixel of the image having a color corresponding to the size of a respective cavity, with gray levels achieved using the time-division multiplexing of the cavity. The size and time-division multiplexing of the filters provide a device-independent display of the image with rich chromatic colors.

One aspect of the exemplary embodiment includes a densely-packed, individually-addressable 2-dimensional array of tunable Fabry-Perot cells (filters) with cavities which provide tunable gaps actuated by application of a force. As the gap changes, the reflections off the upper and lower surfaces of the Fabry-Perot cavity interfere, and the resulting wavelength of the transmitted light is that which produces constructive interference. The ability to change the filter wavelength band with time enables the filter to achieve a wider range of wavelengths than can be achieved with other flat panel display systems. The range of colors is dependent on the resolution of the Fabry-Perot filter, which may be from about 5 to 100 nm, e.g., less than 50 nm, and in one embodiment, about 10 nm. Each filter may thus have about thirty-one states in the visible region (400-700 nm) corresponding to thirty-one wavelength bands with a peak wavelength in each band.

In one embodiment, colors may be created by combining the outputs of two or more Fabry-Perot filters such that two or three wavelength bands are mixed together. For example, by combining three filters, each with offset wavelength peaks, a wide range of colors can be rendered. In one embodiment, some of the colors may be created by rapidly shifting the filter between two (or more) states at sufficient speed that the two colors are indistinguishable to the eye and are viewed as a single combined color.

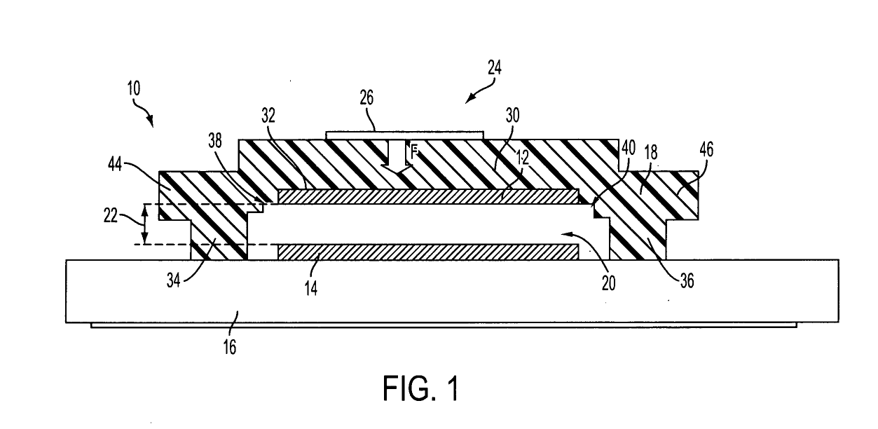

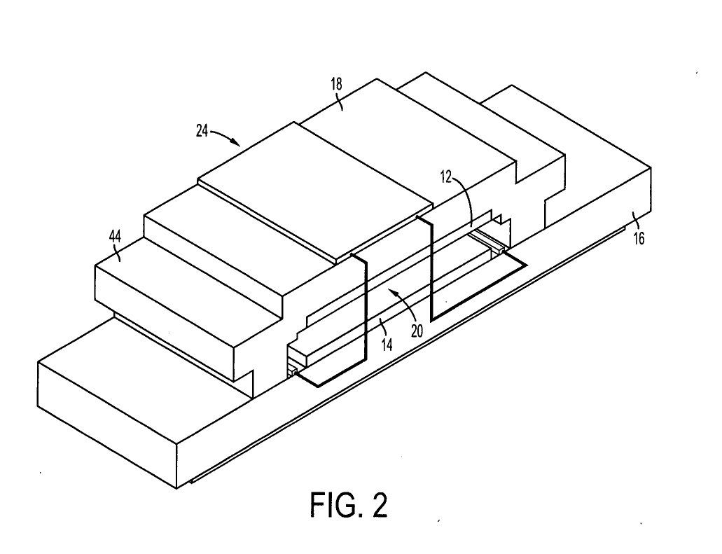

For example, FIG. 1 shows a side sectional view of one embodiment of a micro-electro-mechanically tunable device having a Fabry-Perot (F-P) micro-electro-mechanically tunable Fabry-Perot filter 10 which will be referred to herein as an interferometer or Fabry-Perot filter. FIG. 2 shows a perspective view of an enlarged portion of the Fabry-Perot filter 10. The Fabry-Perot filter 10 may include a first reflector 12 and a second reflector 14 which are supported by a rigid substrate 16. The first reflector 12 is supported along its entire length by a resiliently flexible unitary support body or bridge 18, which is carried by the substrate 16. The first and second reflectors 12 and 14 may be separated by a cavity 20 to define a gap of distance 22 therebetween. The distance 22 represents a dimension of the cavity 20, and may be referred to as a size or height of the cavity 20. The substrate 16 may be a transparent material, such as glass, quartz, or even plastic (e.g., where there is no transistor on the substrate or high temperature process used in forming the device) and may have a thickness of about 200 micrometers to about 5 millimeters. Glass wafers or LCD plates are suitable for the substrate 16. By “transparent” it is meant that a body is generally transmissive to all wavelengths in the visible range of the electromagnetic spectrum (about 400-700 nm) and transmits over 90%, e.g., over 95% of normally incident visible light. The substrate may support a plurality of the filters 10, as will be described in greater detail below.

The support body 18 may be formed from a polymeric material which is transparent in the visible range, such as a photosensitive resin, and may be formed by a photolithographic process. Photosensitive epoxy resins, such as epoxidized multi-functional bisphenol A formaldehyde novolak resins with a medium range molecular weight and at least about 3 epoxy groups per molecule, are suitable. The weight average molecular weight of the epoxy resin may be between about 4,000 and about 10,000. An exemplary resin of this type is SU-8, which is sold by Shell Chemical Company, Houston Tex., under the trademark Epon.

A support body formed of a polymeric material, such as SU-8, has advantages over support systems which are based on typical inorganic materials, such as polysilicon and silicon nitride, in that it has a lower Young's modulus than these materials. For example, the polymeric material may have a Young's modulus of less than about 10 GPa. This reduces the power required to actuate the filter 10.

In one embodiment, the reflectors 12, 14 are formed from a reflective material, such as metal (e.g., silver, gold, or other reflective metal), doped polysilicon, or an oxide such as indium tin oxide (ITO). In one embodiment, at least the second reflector 14, and optionally both reflectors 12, 14 comprise electrically conductive films. The films forming the reflectors 12, 14 are nearly transparent to wavelengths in the visible region of the spectrum. Metal films and polysilicon in general are not as transparent as ITO but may be sufficiently transparent at a thickness of about 10 micrometers (μm), or less. The thickness of the reflectors may be, for example, from about 1 nm to about 2 micrometers.

In other embodiments, the second reflector 14 may include a distributed Bragg reflector (DBR) mirror that includes, for example, three pairs of quarter wavelength Si/SiNₓ stacks. The first reflector 12 may include a DBR mirror that includes two pairs of quarter wavelength Si/SiNₓ stacks. SiNₓ may be Si₃N₄. In another embodiment, one or both of the reflectors may be primarily Si. The addition of the DBR leads to a sharper spectral spike at the desired wavelength, increasing the spectral resolution.

The gap size 22 may be changed in a variety of ways. For example, the size 22 may be changed in a way in which the first reflector 12 stays stationary, while the second reflector 14 moves relative to the first reflector 12. Alternatively, the size 22 may be changed in a way in which the second reflector 14 stays stationary, while the first reflector 12 moves relative to the second reflector 14. Alternatively, the size 22 may be changed in a way in which both the first reflector 12 and the second reflector 14 are moving relative to each other. In various exemplary embodiments, the first reflector 12 and the second reflector 14 maintain parallel with each other regardless of the relative movement there between.

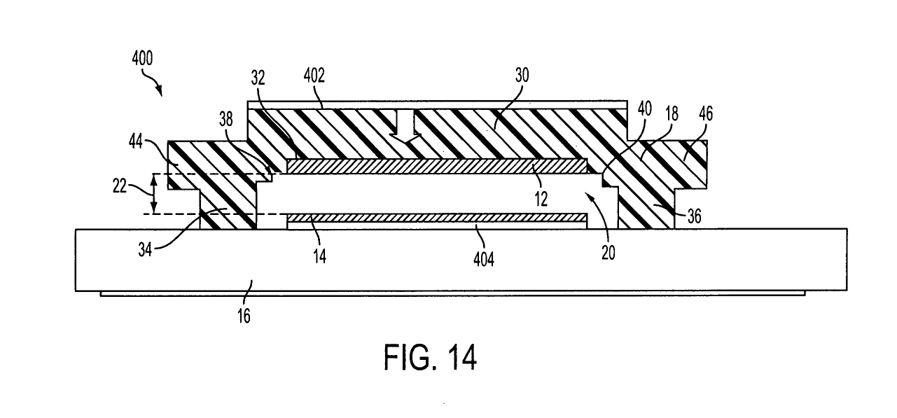

In general, a driving method of a wavelength tunable optical filter can largely be classified into two categories. One is to adjust a distance between reflectors by a force applied to one of the reflectors and to provide a restoration force by a structure connected to the reflector as in an electrostatic scheme and the other is by a deformation of the driving body that is connected to the reflector as in a thermal expansion scheme, an electromagnetic scheme, or an external mechanical force scheme. As shown in FIGS. 1 and 2, the Fabry-Perot filter 10 includes an electrostatic driving scheme in which a driving member 24 adjusts the gap size 22 by deflecting the support body 18 to bring the first reflector 12 closer to the second reflector 14. The illustrated driving member 24 includes a transparent upper electrode 26 such as ITO. The upper electrode may be attracted, for example, to the substrate 16 or to an additional electrode layer (not shown) between reflector 14 and substrate 16, by application of a voltage therebetween. The upper electrode 26 and optional additional electrode can be the same size and shape as the reflector 12, or they may be of a different shape or size, such as a ring around the periphery of the reflector 12. Examples of alternative driving schemes are illustrated in FIGS. 14-16, and are discussed below.

In the exemplary embodiments, the first reflector 12 is maintained in spaced apart relation from the second reflector 14 by the flexible support body 18. The illustrated support body 18 includes a transparent support panel 30, which extends parallel to the substrate 16 and supports the first reflector 12 on a lower surface 32 thereof (i.e., the surface closest to the substrate 16). The support panel may be about 200 nm to about 10 micrometers in thickness. The support body 18 also includes first and second spaced leg members 34, 36 which attach the support panel 30 to the substrate at ends thereof. Notched regions 38, 40, intermediate the leg members 34, 36 and the respective end of the support panel 30 provide a flexing locus about which the support panel 30 flexes. When a force F is applied to the support panel 30 by the driving member 24, the support panel moves relative to the substrate, bringing the reflector 12 closer to reflector 14 and reducing the gap. The restoration force of the support body biases the support panel 30 of the support body away from the substrate when the force is removed.

In other embodiments, the gap size 22 may be adjusted as described, for example in the above-mentioned co-pending applications, incorporated by reference.

The gap dimension 22 is changed or otherwise adjusted between minimum and maximum amounts to adjust the wavelength of light transmitted through the Fabry-Perot filter. For example, first reflector 12 may be displaced to provide a dimensional change in the cavity 20 by applying a force to effect a change in the size 22 of cavity 20 of about 300 to 500 nm. As the size 22 of cavity 20 decreases, for example, the Fabry-Perot transmission peak shifts to shorter wavelengths.

In the Fabry-Perot filter 10 shown in FIG. 1, light may be received at the top reflector 12 of the Fabry-Perot filter 10 through the transparent support panel 30 of support body 18. The received light may be transmitted through the cavity 20 and the transparent substrate 16 at a tuned wavelength. Alternatively, the direction of transmittance may be reversed.

In another embodiment, the substrate 16 may be opaque or reflective. In this embodiment, light is transmitted through the transparent support panel 30 and back out through the support panel after reflection.

The illustrated support body 18 includes flanges 44, 46 which extend outwardly from the support panel 30. These may be connected with the corresponding flanges of adjacent filters 10 in an array.

The Fabry-Perot device 10 illustrated in FIGS. 1 and 2 has a variety of applications including in display panels and image projection systems, as a color filter for LCDs (as a replacement for the conventional filter wheel), in color sensors (spectrophotometers), as described for example in co-pending application Ser. No. 10/833,231 and U.S. Pat. No. 6,295,130, and in chemical analysis. For example, one embodiment of the filter is in a projection display system, such as a projection television which incorporates an array of the filters 10, as disclosed, for example, in Gulvin, et al.

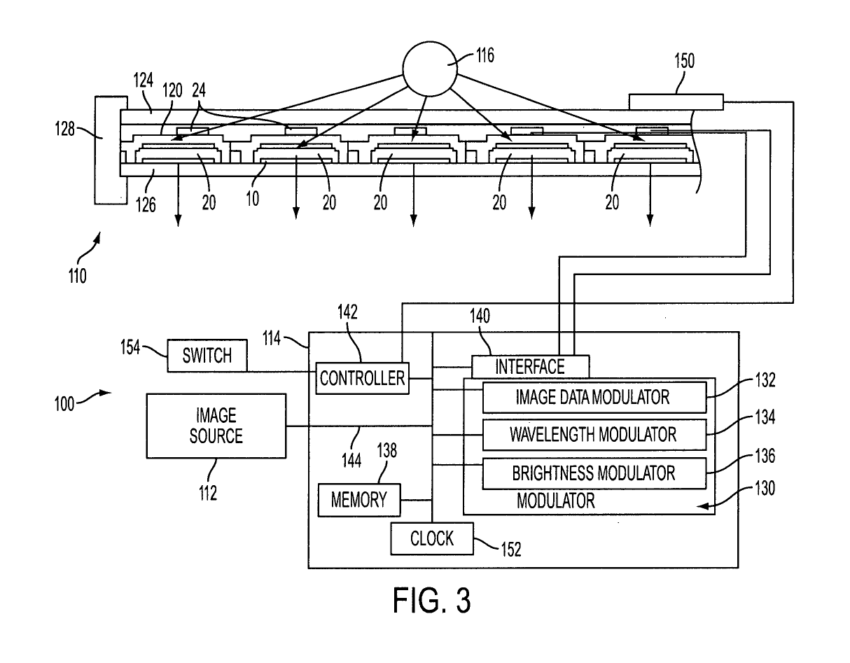

With reference now to FIG. 3, an exemplary display system 100 includes a display apparatus 110, an image source 112, a control system 114, and a source of illumination 116. The display apparatus 110 incorporates an array of Fabry-Perot filters, such as the filter 10 of FIGS. 1 and 2. Only a portion of the display apparatus 110 is shown, with the Fabry-Perot filters 10 greatly enlarged for clarity.

The illustrated display apparatus 110 includes a two-dimensional array 120 of tunable Fabry-Perot filters 10 which may be addressable individually or addressable as small groups of Fabry-Perot filters. In the illustrated embodiment, the array is sandwiched between parallel plates 124, 126 of transparent material, such as glass. The plates 124, 126 are bordered by a rectangular supporting frame 128 of wood, plastic, metal, or other suitable construction material. One of the plates 126 may be the substrate 16 on which the Fabry-Perot filters are formed or may be a separate substrate.

The image source 12 may be any suitable source of digital images, such as color images, and can include, for example, one or more of a digital video disk (DVD) player, a wireless television tuner (e.g., receiving local or satellite signals), a cable television tuner (e.g., making use of electrical or optical signal reception), a wireless computing device (e.g., a laptop computer, a personal digital assistant (PDA), and a tablet computer), and a dedicated device such as a disk, program, or routine which stores control values for one or more images.

The source of illumination 116 may be natural light, such as sunlight and/or one or more white light sources, such as one or more of halogen lamps, fluorescent lamps, LEDs, or other sources capable of generating light in wavelengths throughout the visible range of the spectrum when energized. The range of colors which can be achieved is dependent, to some degree, on the light source, since if the source has gaps in its spectrum, the display apparatus will not be able to display that wavelength, regardless of the filter's characteristics. If the strength of the illumination varies over the spectrum (as does sunlight), this could be accommodated by altering the amount of time that the filter dwells in each state, spending longer at the colors that have less representation in the illumination.

The array 120 may include at least 600 devices (filters) per linear inch (dpi) as an N×M array, where N and M are integers. In some embodiments, the filters 22 may be less than 50 μm in both dimensions of the plane, e.g., 20-25 μm, corresponding to about 1000-1200 dpi. In alternative embodiments, the filters 10 may also be arranged in other geometrical shapes, such as a triangle, a diamond, a hexagon, a trapezoid, or a parallelogram. The array may be subdivided into blocks, each with a separate substrate 16, which may form a block of cavities. A plurality of the blocks may be used in an array to form a larger display apparatus 110.

The control system 114 may address the Fabry-Perot filters 10 individually or in small clusters to achieve a selected wavelength band of each pixel in the image and a selected gray level or intensity. The illustrated control system includes a modulator 130 comprising an image data modulator 132, a wavelength modulator 134, and a brightness modulator 136, which may be individual components or combined into a single modulation component. In addition to the modulator 130, the control system 114 may further include a memory 138, an interface device 140, and a controller 142, all interconnected by a connection or data control bus 144. In the case of a display lit by low ambient lighting, it may not be desirable to use a variation of brightness levels but rather to employ the maximum achievable brightness. Thus the brightness modulation component may be eliminated. Further, where a limited number of images are to be displayed, these may be stored in a form which requires no conversion and thus the image data modulator 132 may be eliminated.

The modulator 130 may by connected to the Fabry-Perot array 120, and may include a gap control circuit that controls the relative movement of the reflectors in each cavity. Based on image modulation data, each filter 10 is controlled to have a desired cavity size to allow transmission of a particular wavelength band or collective wavelength band. The particular or collective wavelength band corresponds to the color of a respective image pixel.

The Fabry-Perot filters may also be controlled to provide multiple gray levels (brightness levels) for each color-separated image pixel. For example, the cavity 20 may be controlled through time-division multiplexing of the transmitted light to provide multiple gray levels for each color-separated image pixel. The exemplary Fabry-Perot filter is one which can be adjusted such that any electromagnetic radiation which is transmitted is outside the bandwidth of the perceptual limit of human eyes (the “visible range”), generally 400-700 nm. By shifting between a state in which the Fabry-Perot filter transmits in the visible range and one in which any radiation transmitted is outside the visible range, different gray levels can be achieved. A pixel is fully “on” when all pre-selected transmission wavelengths are swept within the visible range. The bandwidth is typically less than 60 milliseconds. The pixel is fully “off” when no light in the visible range is transmitted. Transmission that is between these two limits creates gray-scale levels.

To limit the amount of light contributing to an image pixel, unwanted light may be moved into a non-visible part of the spectrum, such as ultraviolet or infrared. Alternatively, unwanted light may be completely blocked by properly adjusting the size of the cavity. For example, to display a wavelength of light at half brightness, the membrane may spend half of its time set to the gap (size of the cavity) for that wavelength, and the other half at a gap that does not have constructive interference anywhere in the visible spectrum.

The display system 100 may further include a sensor 150 such as an optical sensor or a temperature sensor which is in communication with the control system 114 for automatic control of the displayed image. In one embodiment, the sensor 150 is a temperature sensor which responds to temperatures at or in the region surrounding the display apparatus 110. The sensor 150 may be incorporated into the display apparatus 110, or located proximate thereto. In this embodiment, the display apparatus 110 may be controlled in accordance with the detected temperature. For example, the display apparatus may be incorporated into a window of a building and the image may be a uniform color, such as gray or brown, across the array, which is increased in brightness (gray level) as the ambient temperature increases to control the amount of light (or heat) which passes through the window. This may be achieved by controlling the filters through time division multiplexing to adjust the amount of time spent in the visible range.

In another embodiment, the display system 100 includes a clock 152 which changes the image displayed according to the time of day. For example, the display apparatus 110 may be incorporated into a shop or other business sign. One image may include words such as “We're open,” which is displayed during opening hours, and another image, words such as “We're closed,” which is displayed during the hours that the business is closed. In another embodiment, the display system may include a switch 154, which allows a user to switch between two or more displayed images.

In time-division multiplexing, the time resolution of a driving circuitry, such as the modulator 130 or a circuitry used in connection with the modulator, sets a limit to the number of gray levels (brightness levels) possible for a wavelength. For example, if T is the time limit of human eyes perceptual time bandwidth to response to changes in color and i represents the tunable discrete peak wavelengths for the transmission spectra available in the Fabry-Perot tunable filter, then, for a transmission mode display, the gray levels may be represented by the following integral equation:

$${g}_{i} ( t ) = \frac{{\int }_{0}^{t} {\int }_{{λ}_{min}}^{{λ}_{max}} {S}_{i} ( λ ) ⅆ λ ⅆ t}{{g}_{i\_ 100}} \qquad ( 1 )$$

where Sᵢ (λ) represents the transmission spectra of the Fabry-Perot filter for a discrete peak wavelength setting represented by index i,

λₘᵢₙ and λₘₐₓ are minimum and maximum wavelengths in the visible range of the light spectra or any suitable range required for integrating the transmission wavelengths,

gᵢ_{_{—}}₁₀₀ represents the maximum gray level for channel index i used to normalize the gray level gᵢ(t).

When there are N number of gray levels required for the display apparatus (N is typically 256 for a display system) and under time division multiplexing, the total time over which the channel i is left “on” satisfies the following condition:

$$T \leq {\sum }_{i = 1}^{N} {T}_{i} \qquad ( 2 )$$

Modified versions of Equations (1) and (2) may be used to create multiple gray levels for transmission-type displays. The gray levels for M number of channels may be expressed as:
gᵢ(j)=TⱼVᵢ for i=1, 2, 3, . . . , M and j=1, 2, . . . , N (3)
where Vᵢ may be obtained, based on Equation (1), from:

$${V}_{i} = \frac{{\int }_{{λ}_{min}}^{{λ}_{max}} {S}_{i} ( λ ) ⅆ λ}{{g}_{i\_ 100}} \qquad ( 4 )$$

Equations (3) and (4) provide gray levels for the display apparatus.

As shown in FIG. 3, light from the source 116 passes through the Fabry-Perot array 120. Modulated light is produced by the Fabry-Perot array and is directed out of the display for viewing. The modulated light may include an image. Each pixel of the modulated image corresponds to one (or more) filters 10 in the array 120. The color of the pixel is controlled by the size 22 of the cavity. The brightness of the pixel is controlled by time-division multiplexing of the cavity. Thus, an array of cavities 20 may correspond to an array of pixels, and thus may correspond to an image having the array of pixels. However, it is to be appreciated that two or more filters 10 may correspond to a single pixel of the image.

In one embodiment, the image data modulator 130 converts the image data received from the image source into modulation data for generating an image. The image data may include color values, such as L*a*b* values or RGB values for each pixel of an image. The modulation data may include control signals for changing voltages applied to the piezoelectric member 24. The applied voltage results in a cavity distance 22 that provides a desired wavelength band for rendering, alone or in combination, the desired color values, and time division signals for controlling the proportion of the time that a filter 10 spends outside the visible range for achieving selected brightness values. The wavelength modulator 134 provides control signals to control the size of a cavity at a particular time. The brightness modulator 136 provides control signals to control the time-division multiplexing of a filter 10. The generated modulated image may be temporarily stored in memory 138 prior to being displayed by the Fabry-Perot display apparatus 110.

The modulated image may be one of a series of images modulated from the white light passing through the array 120. The series of images may be animated, such as in a video or a movie. The series of images may also represent stationary images, such as a view graph or a page of textual content.

In particular, when the light passes through the array 120, enough color sweeps may be obtained from the array in a spectral space that cover a range of colors required for the pixels by corresponding adjustment of the Fabry-Perot cavity size using modulating data from the wavelength modulator 134. The color sweeps may be carried out at a high frequency, such as 20 Hz (twenty complete cycles from one bandwidth to the other and back again) or greater, so that human eyes are not able to distinguish between filtered color coming out of the discrete gap setting. In one embodiment the filter is shifted between bandwidths at a frequency of 60 Hz or greater (equivalent to about 15-20 ms). Thus, the display apparatus 110 may display color images in various wavelengths by transmitting selectively very narrow wavelengths or collectively a group of wavelengths for each image pixel. Similarly, for time division multiplexing, the brightness modulator 136 may shift between bandwidths, only in this case the second bandwidth is outside the visible range.

The Fabry-Perot array 120 may include a two-dimensional array filters and may be a matrix addressable as a group, or independently, depending on the application. In the matrix addressable as a group, more than one Fabry-Perot cavity will be actuated together to transmit the same wavelengths. Addressing a group or single cavity independently allows different wavelengths to pass through the filter at the same time. The actuation of the addressing may be performed by the modulator 130, by modulating the voltage signals provided to drive the cavities 20.

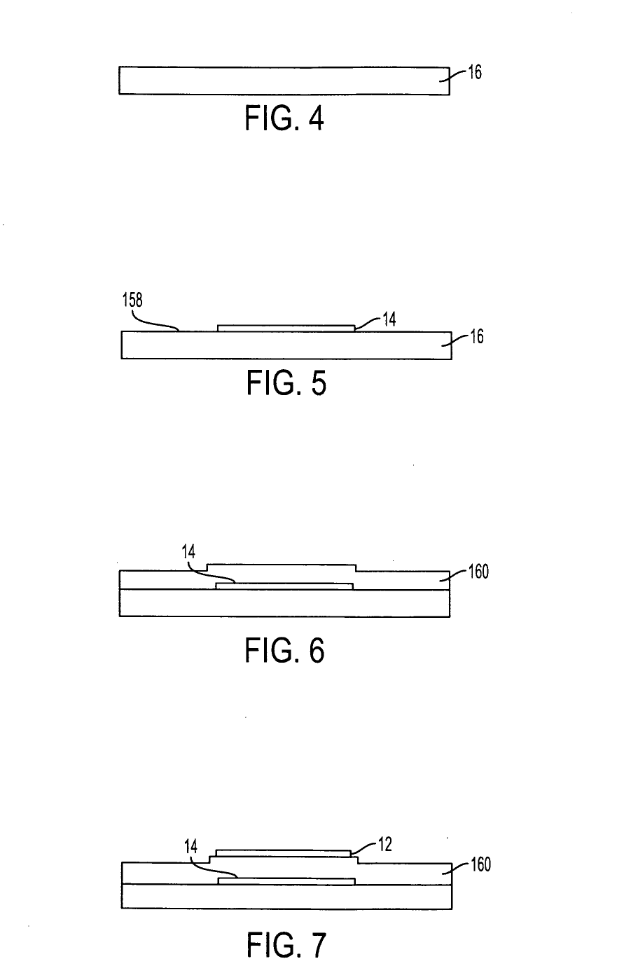

FIGS. 4-10 illustrate an exemplary method for forming the Fabry-Perot filter 10. The method begins as illustrated in FIG. 4 with the provision of a transparent substrate 16. A surface 158 of the substrate may be cleaned to remove impurities. A thin layer of gold, silver, ITO, or doped polysilicon for forming the bottom reflector 14 is then deposited on the substrate surface 158. The reflector layer is patterned to define the shape of the bottom reflector 14 (FIG. 4). Where the reflector layer is not electrically conductive, an electrically conductive bottom electrode layer (not shown) may be formed below or adjacent to the reflector layer. A sacrificial layer 160 is then deposited over the bottom reflector 14 (FIG. 6). Suitable materials for forming the sacrificial layer include polymers, such as conventional photoresist materials, polysilicon, metals (such as chromium, copper, aluminum), and the like. The sacrificial material is one which can be etched by a suitable etching technique, such as a wet or dry etching technique, without destruction of the reflector layers 12, 14. The layer has a thickness of about 0.5 nm to about 500 nm, i.e., the width 22 of the gap. A second layer of gold, silver, ITO, or doped polysilicon is deposited on top of the sacrificial layer and patterned to define the top reflector 12 (FIG. 7). The sacrificial layer 160 is then patterned and etched to define spaced vias 162, 164 which extend through the sacrificial layer to the substrate 16 below (FIG. 8). The sacrificial layer may be an organic material which can be released with a solvent, such as acetone. Alternatively, the sacrificial layer may be a metal, such as Cr or Al, which can be released with a corresponding Cr or Al etch solution. The vias 162, 164 may be the width of the legs 34, 36, e.g., at least about 0.5 micrometers wide and can be up to about 3 micrometers wide and can be laterally spaced slightly from the reflectors 12, 14 by a portion of the sacrificial layer 160. SU-8 or other suitable photosensitive epoxy is spin coated over the structure to fill the vias 162, 164 and provide a continuous layer having a thickness t of from about 200 nm to about 5 micrometers extending over the top electrode 12. The epoxy may be soft-baked, for example, with a hot plate at a temperature of about 65° C. for about 1 min and post-exposure baked at about 95° C. for about 2 min, and then patterned to define the support body 18 (FIG. 9). The epoxy may then be hard-baked at about 150° C. for about 30 min. The sacrificial layer is then etched away to define the air gap 20. For example, the wafer is soaked in acetone to remove the organic sacrificial layer. Subsequently, the drive member 24 may be formed on the top of the support body panel. For example, an ITO layer 26 can be sputter coated on top of the support body 18 using a shadow mask.

The exemplary method of forming the Fabry-Perot filter 10 thus described avoids the need to etch through a silicon wafer, as in some conventional processes. This significantly reduces the cost and time for forming the filter 10. The resulting filter 10 is monolithically integrated, i.e., it can be formed on the substrate without the need for wafer bonding. Wafer bonding is an expensive process and also can result in misalignment and defects in the devices attached in such a process, thereby reducing the overall yield.

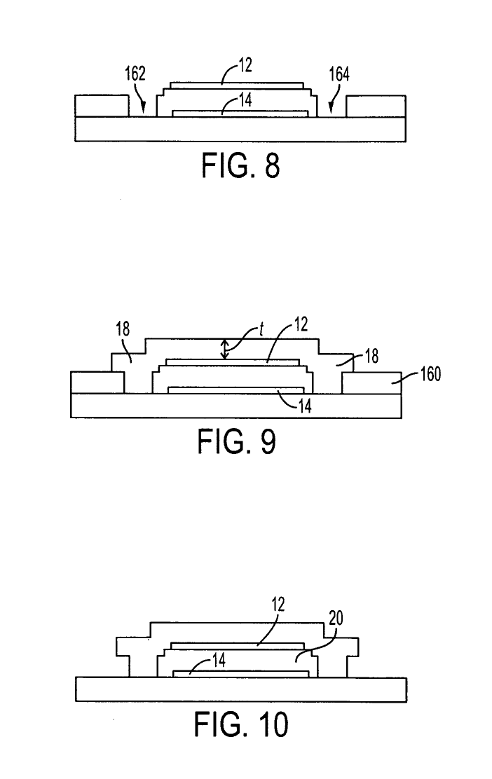

FIG. 11 illustrates one exemplary embodiment of a display system 200 including a display apparatus 202 analogous to display apparatus 110. The display apparatus 202 forms a window of a building. The display apparatus 202 includes an array 120 which is analogous to the array of FIG. 2 and a frame 128 which forms a part of the window frame. Alternatively the display apparatus 202 may be mounted adjacent an existing window or transparent door panel of the building. The illustrated display apparatus 202 also includes a light or temperature sensor 150. A control system 114 may be remote from the display and may also control one or more additional window display apparatus in a similar manner.

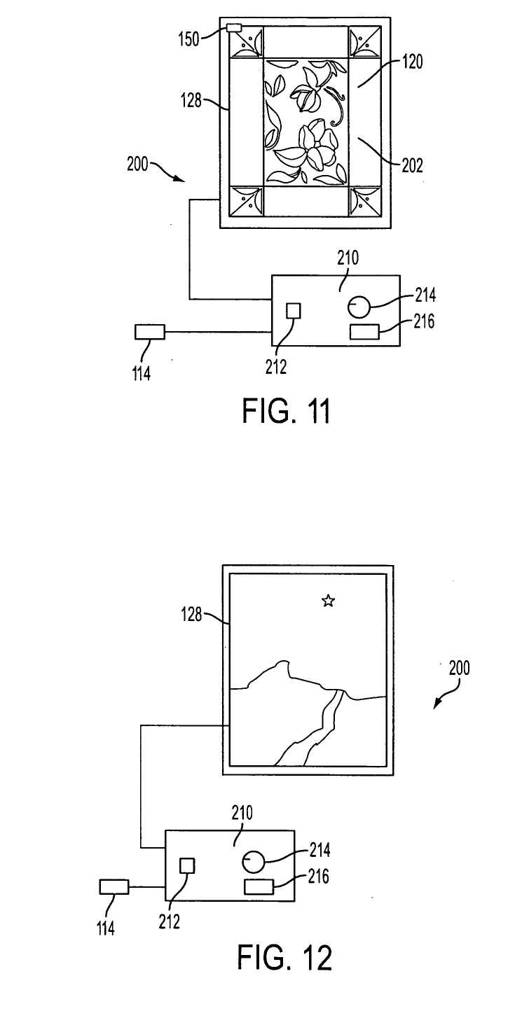

The display system 200 may have two or more modes. In a first mode (FIG. 11), a first image, “stained glass” in the exemplary embodiment, is displayed. In the second mode (FIG. 12), a second image, or no image is displayed. The display system 200 may include a user-accessible control panel 210 which includes a power switch 212, a mode switch 214, and a clock 216. The user can use the mode switch 214 for selection between a plurality of images and/or for switching between manual changeover and automatic changeover (e.g., according to the clock, a sensed temperature, or a sensed illumination level).

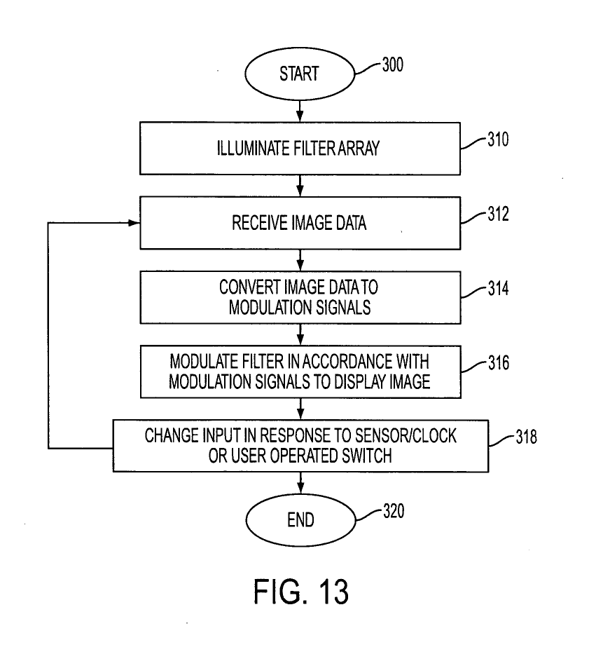

FIG. 13 outlines an exemplary process for controlling a display apparatus. It is understood that the order of steps need not necessarily be as shown in FIG. 13 and that one or more of the steps in FIG. 13 may be omitted or that different steps may be provided. The process starts at step S300 and proceeds to step S310, where light from a source of illumination is received at the display apparatus 110, 202. Next, at step S312, image data is received. At step S314, the data is converted to modulation signals which include wavelength information and brightness information. At step S316 an array of the display apparatus is controlled to generate an array of respective pixels of an image based on the modulation signals. Then, in step S318, the display may be changed, for example, by manual actuation of a switch 154, 214 or an automated timed or temperature operated switch, in which case, the method returns to step S312. The process ends at step S320.

The method illustrated in FIG. 13 may be implemented in a computer program product that may be executed on a computer, such as a dedicated microprocessor. The computer program product may be a computer-readable recording medium on which a control program is recorded, or may be a transmittable carrier wave in which the control program is embodied as a data signal.

With reference now to FIG. 14, another embodiment of a Fabry-Perot filter 400 is illustrated which employs an electrostatic driving scheme. The filter 400 is analogous to filter 10 except as noted. In this embodiment, the driving member 24 includes first and second transparent electrodes 402, 404. By applying a voltage between the electrodes 402, 404, the support panel 30 is drawn toward the substrate 16 to vary the gap size 22. Indium tin oxide (ITO) may be used for forming the transparent electrodes 402, 404.

While the first electrode 402 is shown on top of the support panel 30 (i.e., the side furthest from the substrate) it is also contemplated that the electrode 402 may be formed on the underside of the support panel, intermediate the support panel and the reflector 12.

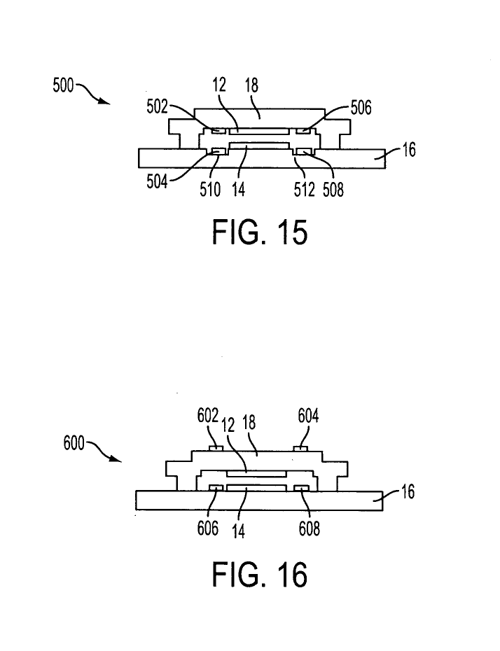

With reference now to FIG. 15, another embodiment of a Fabry-Perot filter 500 is illustrated which employs an electrostatic driving scheme. The filter 500 is analogous to filter 10 except as noted. Similar elements are accorded the same numerals and new elements have new numerals. The driving member 24 includes upper and lower spaced pairs of electrodes 502, 504, 506, 508. Upper electrodes 502, 504 are formed adjacent upper reflector 12. Lower electrodes 506, 508 are recessed in sockets 510, 512 formed in the substrate, on either side of the lower reflector 14 and in parallel with the corresponding upper electrode. In this embodiment, the electrodes 502, 504 need not be transparent but may be opaque. A voltage applied between the pairs 502, 506 and 504, 508 of the upper and lower electrodes provides the electrostatic force to drive the member 24.

With reference now to FIG. 16, another embodiment of a Fabry-Perot filter 600 is illustrated which employs an electrostatic driving scheme. The filter 600 is analogous to filter 10 except as noted. Similar elements are accorded the same numerals and new elements have new numerals. The driving member 24 includes upper and lower spaced pairs of electrodes 602, 604, 606, 608. Upper electrodes 602, 604 are formed adjacent upper reflector 12. Lower electrodes 606, 608 are formed on the substrate, on either side of the lower reflector 14 and in parallel with the corresponding upper electrode. In this embodiment, the electrodes 602, 604 need not be transparent but may be opaque. A voltage applied between pairs 602, 606 and 604, 608 of the upper and lower electrodes provides the electrostatic force to drive the member 24.

While in the embodiments of FIGS. 15 and 16, a portion of the devices will not be in an optically active area, they provide alternative driving schemes which have advantages in some applications. For example, the recessed electrodes 506, 508 of FIG. 15 provide a larger gap between the upper electrodes and lower electrodes without changing the optical gap 22.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A tunable Fabry-Perot filter comprising:
a substrate;
a support body supported by the substrate, the support body including a transparent support panel which is spaced from the substrate by first and second spaced leg members;
a first reflector supported on the substrate intermediate the first and second leg members;
a second reflector supported on the transparent support panel intermediate the first and second leg members, the first and second reflectors defining a gap therebetween; and
a driving member which adjusts a size of the gap by displacement of the support panel to modulate a wavelength of light output by the filter.

2. The Fabry-Perot filter of claim 1, wherein the substrate is transparent.

3. The Fabry-Perot filter of claim 2, wherein the substrate is formed from at least one of the group consisting of glass, quartz, and plastic.

4. The Fabry-Perot filter of claim 1, wherein the support body is flexible.

5. The Fabry-Perot filter of claim 1, wherein the support panel is primarily formed from an organic resin.

6. The Fabry-Perot filter of claim 5, wherein the support panel is formed from an epoxy resin.

7. The Fabry-Perot filter of claim 5, wherein the support body is integrally formed from an organic resin.

8. The Fabry-Perot filter of claim 1, wherein the first reflector is substantially coextensive with the support panel.

9. The Fabry-Perot filter of claim 1, wherein at least one of the first and second reflectors comprises a reflective metal film or a distributed Bragg reflector (DBR) mirror.

10. The Fabry-Perot filter of claim 1, wherein the driving member comprises a piezoelectric member which applies a force to the support panel.

11. The Fabry-Perot filter of claim 1, wherein the driving member comprises an electrostatic driving member.

12. A display apparatus comprising a plurality of the tunable Fabry-Perot filters of claim 1.

13. The display apparatus of claim 12, further comprising a modulator which provides wavelength modulation signals to the plurality of Fabry-Perot filters to modulate a color of pixels in an image.

14. The display apparatus of claim 13, wherein the modulator causes selected ones of the Fabry-Perot filters to shift into the bandwidth outside the visible range to modulate a brightness of pixels in the image.

15. The display apparatus of claim 12, further comprising a source of illumination which provides light to the plurality of Fabry-Perot filters.

16. A method of forming a Fabry-Perot filter comprising:
forming a first reflective layer on a surface of a substrate;
forming a sacrificial layer over the first reflective layer;
forming a second reflective layer over the sacrificial layer;
defining vias through the sacrificial layer;
forming a support body over the sacrificial layer which extends into the vias; and
removing the sacrificial layer to define a gap intermediate the first and second reflective layers.

17. The method of claim 16, wherein the forming of the support body comprises depositing an organic resin over the second layer of reflective material and in the vias.

18. The method of claim 17, wherein the organic resin comprises an epoxy resin.

19. The method of claim 16, wherein the sacrificial layer is formed from a material selected form the group consisting of organic photoresist materials, polysilicon, metals, and combinations thereof.

20. The method of claim 16, further comprising incorporating a driving member for selectively displacing the support body to adjust a size of the gap.

21. The method of claim 16, further comprising forming a plurality of the Fabry-Perot filters on the substrate.

22. A display system comprising:
an array of tunable Fabry-Perot filters supported on a common substrate, each of the filters comprising:
a resiliently flexible transparent support body supported by the substrate, the support body being formed of an organic resin;
a first reflector supported by the substrate; and
a second reflector supported by the transparent support body, the first and second reflectors defining a gap therebetween, a size of the gap being adjustable by flexing of the support body to modulate a wavelength of light output by the Fabry-Perot filter.
